(19) United States
(12) Patent Application Publication
(10) Pub. No.: US 2026/0024516 A1
(43) Pub. Date: Jan. 22, 2026

(54) ACOUSTIC TRANSMISSION ENHANCER AND ACOUSTIC TRANSMISSION ENHANCEMENT SYSTEM

(71) Applicant: Murata Manufacturing Co., Ltd., Nagaokakyo-shi (JP)

(72) Inventors: Mudassir HUSSAIN, Nagaokakyo-shi (JP); Kazuki NAGASHIMA, Nagaokakyo-shi (JP); Hiroyuki NAKANO, Nagaokakyo-shi (JP); Yoshiyuki KUNIFUSA, Nagaokakyo-shi (JP); Masaya NISHIDA, Nagaokakyo-shi (JP); Yun JING, University Park, PA (US); Jun JI, University Park, PA (US); Hyeonu HEO, University Park, PA (US); Mourad OUDICH, University Park, PA (US)

(21) Appl. No.: 19/339,416

(22) Filed: Sep. 25, 2025

Related U.S. Application Data
(63) Continuation of application No. PCT/US2023/081968, filed on Nov. 30, 2023.
Application No. PCT/US2023/081968 is a continuation of application No. 18/127,181, filed on Mar. 28, 2023.

(51) Int. Cl. G10K 11/04; G10K 11/24

(52) U.S. Cl. CPC G10K 11/04; G10K 11/24

(57) ABSTRACT

An acoustic transmission enhancer that includes a resonance-based metamaterial and a material connected to the metamaterial, wherein the metamaterial and the material are arranged such that acoustic waves pass through the metamaterial and the material in the acoustic transmission enhancer. An acoustic transmission enhancement system that includes: a material in a medium; a resonance-based metamaterial on the material; and a transducer that emits acoustic waves to the material and the metamaterial through the medium, wherein a straight line along a direction in which the transducer emits the acoustic waves intersects the metamaterial and the material.

### CROSS REFERENCE TO RELATED APPLICATIONS

The present application is a continuation of International application No. PCT/US2023/081968, filed Nov. 30, 2023, which claims priority to U.S. patent application Ser. No. 18/127,181, filed Mar. 28, 2023, the entire contents of each of which are incorporated herein by reference

### FIELD OF THE INVENTION

The present disclosure relates to an acoustic transmission enhancer and an acoustic transmission enhancement system.

### BACKGROUND OF THE INVENTION

Patent Literature 1 discloses a non-Hermitian complementary metamaterial (NHCMM) configured to add a first amount of energy amplification coherently to the acoustic wave to account for acoustic wave energy loss as a result of the wave propagating through the specimen. A non-Hermitian complementary metamaterial (NHCMM) is basically an active circuit wired to a layer of piezoelectric material, which is designed to achieve a negative value of the complex effective density and a negative value of the effective speed of sound. The design disclosed in Patent Literature 1 is an active system with an op-amp.

Non-Patent Literature 1 discloses non-foster circuits and a stability theory.

Patent Literature 1: US2021/137487

Non-Patent Literature 1: Stearns S. D., “Non-Foster circuits and stability theory”, IEEE International Symposium on Antennas and Propagation (APSURSI) (IEEE, 2011).

### SUMMARY OF THE INVENTION

The design disclosed in Patent Literature 1 has multiple issues.
1. Power consumption increases. The design needs an op-amp that requires additional DC power supplies.
2. Noise is a common issue for an op-amp. The noise from an op-amp disrupts the acoustic signal of interest, resulting in a low sign-to-noise ratio.
3. The design is complex to avoid the instability of the gain circuit. See Non-Patent Literature 1 for detail.
4. The bandwidth may be very narrow in some cases. Patent Literature 1 nowhere discloses a power transmission plot as a function of frequency, and the bandwidth is assumed to be very low. This is because the condition to simultaneously achieve a negative value of complex effective density and a negative value of complex effective speed of sound is very strict.

The present disclosure was made to solve the above issues and aims to provide an acoustic transmission enhancer and an acoustic transmission enhancement system, which enhance the acoustic transmission through a material placed in a medium.

In one embodiment, the present disclosure provides an acoustic transmission enhancer that includes a resonance-based metamaterial and a material connected to the metamaterial, wherein the metamaterial and the material are arranged such that acoustic waves pass through the metamaterial and the material in the acoustic transmission enhancer.

In another embodiment, the present disclosure provides an acoustic transmission enhancement system, including: a material in a medium; a resonance-based metamaterial on the material; and a transducer that emits acoustic waves to the material and the metamaterial through the medium, wherein a straight line along a direction in which the transducer emits the acoustic waves intersects the metamaterial and the material.

The present disclosure provides an acoustic transmission enhancer and an acoustic transmission enhancement system, which enhance the acoustic transmission through a material placed in a medium.

### BRIEF DESCRIPTION OF THE DRAWINGS

FIG. 1 is a schematic cross-sectional view of an example acoustic transmission enhancer according to an embodiment of the present disclosure.

FIG. 2 is a schematic perspective view of an example resonating structure of a metamaterial according to an embodiment of the present disclosure.

FIG. 3 is a schematic perspective view of another example resonating structure of the metamaterial according to an embodiment of the present disclosure.

FIG. 4 is a schematic perspective view of another example acoustic transmission enhancer according to an embodiment of the present disclosure.

FIG. 5 is a schematic perspective view of a simulation model according to Example 1.

FIG. 6 is a schematic perspective view of a resonating structure used in the simulation according to Example 1.

FIG. 7 is a graph showing results of simulation according to Example 1, with power transmission plotted against frequency.

FIG. 8 is a schematic perspective view of a simulation model according to Example 2.

FIG. 9 is a schematic perspective view of a resonating structure used in the simulation according to Example 2.

FIG. 10 is a graph showing results of simulation according to Example 2 and Comparative Example 1, with power transmission plotted against frequency.

FIG. 11 is a schematic plan view of an acoustic transmission enhancer according to Example 3.

FIG. 12 is a schematic view of a setup of an experiment according to Example 3.

FIG. 13 is a schematic view of a setup of an experiment according to Example 3′.

FIG. 14 is a schematic view of a setup of an experiment according to Comparative Example 2.

FIG. 15 is a schematic view of a setup of an experiment according to Comparative Example 3.

FIG. 16 is a graph showing experimental results according to Examples 3 and 3′ and Comparative Examples 2 and 3, with power transmission plotted against frequency.

### DETAILED DESCRIPTION OF THE PREFERRED EMBODIMENTS

Hereinafter, the acoustic transmission enhancer and the acoustic transmission enhancement system of the present disclosure are described.

The present invention is not limited to the following preferred embodiments and may be suitably modified without departing from the gist of the present invention. Combinations of two or more preferred features described in the following preferred embodiments are also within the scope of the present invention.

### Acoustic Transmission Enhancer

First, an acoustic transmission enhancer according to an embodiment of the present disclosure is described.

According to the present embodiment, the present disclosure provides an acoustic transmission enhancer through a material placed in a medium, including a resonance-based metamaterial. The acoustic transmission enhancer according to the present embodiment includes a resonance-based metamaterial and thus can enhance the acoustic transmission through the material placed in the medium.

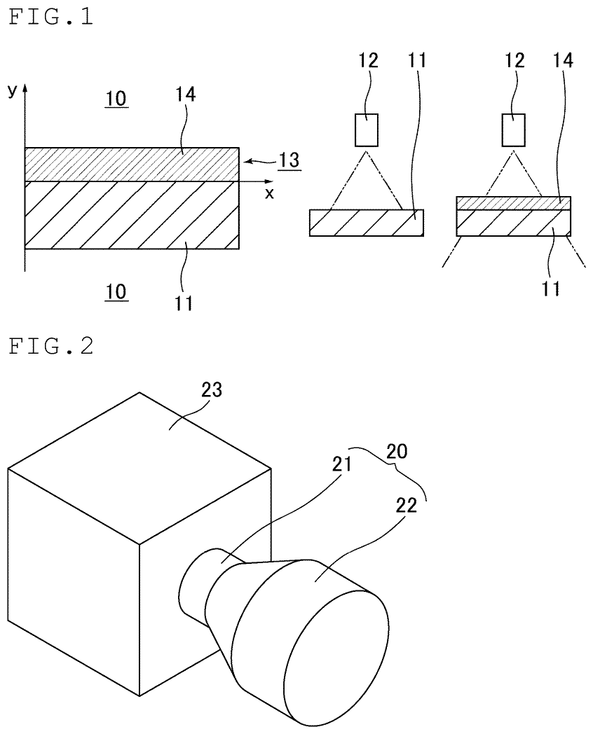

FIG. 1 is a schematic cross-sectional view of an example acoustic transmission enhancer according to an embodiment of the present disclosure. FIG. 1 also shows a system without a metamaterial for comparison.

Acoustic waves cannot be transmitted from a medium 10 (background medium) to another material 11 (aberrating layer) due to impedance mismatch between the medium and the material (see the central portion of FIG. 1). Acoustic waves emitted by the transducer 12 or the like propagate through the medium 10 and reach the material 11, but the acoustic waves are reflected by the material 11 and do not transmit through the material 11. In contrast, an acoustic transmission enhancer 13 according to the present embodiment includes a resonance-based metamaterial 14 (see the left portion of FIG. 1) and thus can enhance acoustic transmission through the material 11 placed in the medium 10 (see the right portion of FIG. 1). Acoustic waves emitted by the transducer 12 or the like propagate through the medium 10. The acoustic waves that reach the material 11 transmit through the material 11 due to the resonance effect of the metamaterial 14. At and near the resonance frequency, the metamaterial 14 undergoes strong vibration due to the resonance effect. The resonating metamaterial 14 works as a secondary acoustic source to re-radiate the acoustic wave to the other side of the material 11, which would otherwise have a very limited power transmission without the metamaterial 14. So, the acoustic metamaterial enhances the ultrasound transmission. In other words, the metamaterial 14 reduces the reflection of acoustic waves by the material 11. The present embodiment opens the possibility for noninvasive, wireless, and contactless acoustic transmission through aberrating layers.

As described above, preferably, the metamaterial includes a resonating structure to reduce acoustic energy loss due to impedance mismatch between the medium and the material, thus enhancing the acoustic transmission through the material. Owing to the presence of the resonating structure, the metamaterial can reduce acoustic energy loss due to impedance mismatch between the medium and the material. In other words, the acoustic waves can be transmitted and enhanced while propagating from one medium to another medium by accounting the impedance mismatch between the media.

In order to effectively enhance the acoustic transmission, a ratio Z₂/Z₁ of impedance Z₂ of the material to impedance Z₁ of the medium is preferably greater than 0 and 110,000 or less (except 1), more preferably 3 to 5,000.

The impedance Z₁ and impedance Z₂ can be calculated from the following equation:

Z=√ρ×√β

wherein ρ indicates the density, and β indicates the bulk modulus.

Table 1 below shows example combinations of the medium and the material and the impedance ratio Z₂/Z₁ of each combination. Table 1 also shows whether each combination has the acoustic transmission enhancement effect on the metamaterial.

TABLE 1

| | | | Impedance ratio | |
|---|---|---|---|---|
| | | | Material/Medium | Transmittance |
| | Material | Medium | (Z) | (with Metamaterial) |
| 1 | Bone | Water | 3 | Good |
| 2 | Aluminum | Water | 11 | Good |
| 3 | SUS316L | Water | 30 | Good |
| 4 | Polypropylene | Air | 5,000 | Good |
| 5 | SUS316L | Air | 110,000 | Fair |

As shown in Table 1, the present inventors confirmed that the acoustic transmission enhancement effect by the metamaterial can be achieved in a wide range where the ratio Z₂/Z₁ is 110,000 or less. The acoustic transmission enhancement effect is high particularly at the ratio Z₂/Z₁ of 5,000 or less.

The acoustic transmission enhancer according to the present embodiment achieves the following effects.
1. The metamaterial according to the present embodiment is a passive metamaterial and does not require an op-amp that requires additional DC power supply. Thus, the metamaterial requires less power consumption than the design mentioned in Patent Literature 1.
2. Since no op-amp is used in the present embodiment, the op-amp noise issue mentioned in Patent Literature 1 is solved.
3. The metamaterial according to the present embodiment has a simple design that can be fabricated with current 3D printing technology.
4. The metamaterial according to the present embodiment has a wider bandwidth than complementary metamaterials (CMM) and non-Hermitian complementary metamaterials (NHCMM).

The medium is a background medium that fills the surroundings of the material and the acoustic transmission enhancer (metamaterial). The medium may be any fluid or non-fluid. Examples include gases such as air and nitrogen and liquids such as water, acidic aqueous solutions, alkaline aqueous solutions, blood, and organic solvents. The types of the media before and after the material (before acoustic wave transmission and after acoustic wave transmission) may be the same or different from each other.

The material by itself is a member that obstructs the acoustic wave transmission (causes acoustic energy loss) and may be any material different from the medium. Specific examples include resin materials such as polypropylene, nonmetallic materials such as bone and skin, and metallic materials (or alloys thereof) such as stainless steel, aluminum, silver, and gold. The material may be made of only a single material or multiple different materials.

The form and structure of the material are not limited. Any form and structure of interest to the acoustic application may be employed. For example, the material may be a plate (layer).

The thickness (dimension in a traveling direction of an incident wave) of the material is not limited. The thickness can be as small as 1e-7 m if the working frequency is 1 GHz in air. And the thickness can be as large as 10 m if the working frequency is 10 Hz in air.

The size (dimension in a direction perpendicular to a traveling direction of the incident wave) of the material is not limited and can be appropriately set.

The metamaterial is an acoustic metamaterial consisting of resonating structures that gives rise to resonance in a local frequency range and consequently facilitates the acoustic transmission through the material. It is an artificial substance whose behavior to acoustic waves is different from that of natural substances. Specifically, as described above, the metamaterial reduces acoustic energy loss due to impedance mismatch between the medium and the material, thus enhancing the acoustic transmission through the material.

The metamaterial may be any material. The material may include metals, nonmetals, and alloys. Herein, the term “alloy” refers to a metal made by fusing a metal with a different metal and/or nonmetal. The metamaterial may be made of only a single material or multiple different materials.

The metamaterial may be placed anywhere as long as it is on the material. For example, the metamaterial may be placed in front of the material (before acoustic wave transmission) (see the right portion of FIG. 1) or behind the material (after acoustic wave transmission), or the metamaterials may be placed in front of and behind the material (before and after acoustic wave transmission). In either case, the metamaterial can be placed in direct contact with the material.

A unit element of the metamaterial may have any structure. The metamaterial may include an arbitrarily shaped resonating structure that gives rise to resonance in a local frequency range and consequently facilitates the acoustic transmission through the material. Thus, the metamaterial can be designed in various structures that easily give rise to resonance so as to facilitate transmission through the material.

Here, the local frequency range that gives rise to resonance is not limited. The local frequency may range from 200 GHz to 300 GHz at a resonance peak frequency (frequency showing a transmission peak) of 250 GHz; 400 kHz to 600 kHz at a resonance peak frequency of 500 kHz; or 20 kHz to 60 kHz at a resonance peak frequency of 40 kHz. Each range includes boundary values.

Preferably, the resonating structure includes a mass and spring-based structure that functions as a resonator and that gives rise to resonance in a local frequency range. Such a mass and spring-based structure collectively gives rise to local resonance and consequently facilitates ultrasound transmission through the material. Thus, the mass and spring structure can be used as a resonator.

The mass may be configured such that it is not connected to the material while it is connected to the spring, and the spring may be connected to the material. The mass and the spring may be made of only a single material or multiple different materials (multi-material). The mass may be heavier than the spring. The mass may be larger, equal or smaller than the spring. Alternatively, the mass and the spring may have the same size. The bulk modulus and density of the spring may be smaller, equal, or larger than the bulk modulus and density of the mass, respectively.

FIG. 2 is a schematic perspective view of an example resonating structure of a metamaterial according to an embodiment of the present disclosure.

A resonating structure 20 shown in FIG. 2 includes a relatively narrow spring 21 and a relatively wide mass 22. More specifically, the resonating structure 20 has a cylindrical shape having a narrow side adjacent to a material 23 and made of a single material. A root portion connected to the material 23 and having a relatively narrow cylindrical shape functions as the spring 21, and an end portion having a relatively wide cylindrical shape functions as the mass 22. The resonating structure 20 may be made of the same material as that of the material 23 or may be made of a material different from that of the material 23.

The mass 22 shown in FIG. 2 includes a tapered portion that is gradually tapered toward the spring 21, but the tapered portion is not essential. In other words, the spring 21 may be directly connected to a flat end surface of the mass 22. The spring 21 and the mass 22 shown in FIG. 2 may be made of different materials.

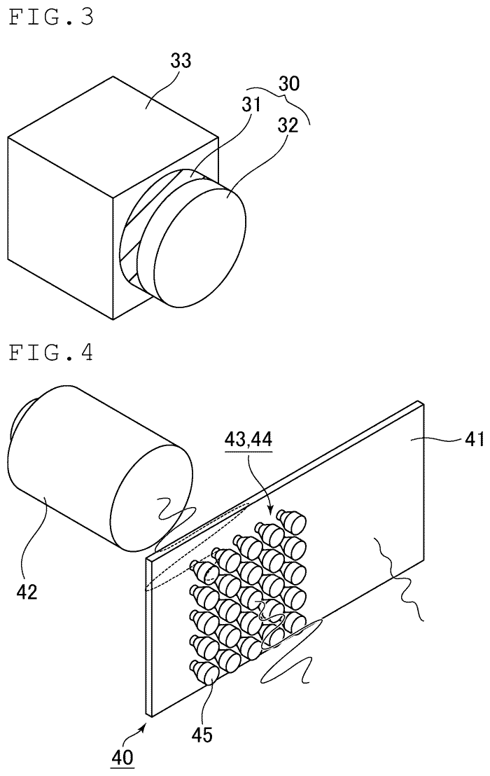

FIG. 3 is a schematic perspective view of another example resonating structure of the metamaterial according to an embodiment of the present disclosure.

A resonating structure 30 shown in FIG. 3 includes a spring 31 relatively having a low bulk modulus and a relatively low density, and a mass 32 having a relatively high bulk modulus and a relatively high density. More specifically, the resonating structure 30 has a cylindrical shape having a constant diameter and consisting of two or more materials. A root portion containing a first material and connected to a material 33 functions as the spring 31, and an end portion containing a second material functions as the mass 32. The first material has a lower density and a lower bulk modulus than the second material. The first material may be made of the same material as that of the material 33 but is usually made of a material different from that of the material 33. The second material may be made of the same material as that of the material 33 or may be made of a material different from that of the material 33. The first material may have a lower density and a lower bulk modulus than the material 33.

The resonating structure of the metamaterial according to the present embodiment may include a structure other than the mass and spring-based structure. For example, the resonating structure may include an elongated structure having a uniform quality. Specific examples include a cylindrical structure having a constant diameter and a uniform quality and an oval structure having a uniform quality with its end in the longitudinal direction cut. Such a resonating structure may be directly connected to the material such that the longitudinal direction of the resonating structure intersects the material (optionally at right angles).

The resonating structure of the metamaterial according to the present embodiment can be produced by a 3D printer. Particularly preferred is a selective laser sintering (SLS) 3D printer. The resonating structure may be formed directly on the material, or the resonating structure that has been formed in advance may be disposed on (e.g., attached to) the material.

The resonating structure may be symmetrically shaped about an axis parallel to a traveling direction of an incident wave. This allows the resonance peak to appear at a high frequency as compared to the case of an asymmetric shape described later. For example, in this case, the resonating structure may be a rotating body. In other words, the resonating structure may have a three-dimensional shape that can be obtained by rotating an arbitrary line around the above-described axis as the axis of rotation.

The resonating structure may be asymmetrically shaped about an axis parallel to a traveling direction of an incident wave. This allows the resonance peak to appear at a low frequency as compared to the case of the symmetric shape described above. For example, in this case, the resonating structure may have a three-dimensional shape that can be obtained by shifting a portion of the symmetric shape (e.g., the mass) in a direction perpendicular to the axis described above.

The acoustic transmission enhancer according to the present embodiment may consist of a single resonating structure. Yet, preferably, the resonating structure includes multiple resonating structures periodically arranged. This can further enhance the acoustic transmission and bandwidth through the material placed in the medium. As described above, the metamaterial may be a material including multiple resonating structures as unit elements (minute units) placed at equal intervals and configured to behave as a homogeneous medium for acoustic waves.

The periodic arrangement may be one-dimensional arrangement but is preferably two-dimensional arrangement. Specific examples of the two-dimensional arrangement include matrix arrangement, staggered arrangement, and circular arrangement. The pitch of the periodically arranged resonating structures may be, for example, 0.1 mm to 10 mm, or 100 nm to 10 μm.

The number of resonating structures periodically arranged is not limited. Yet, a greater number of resonating structures result in higher acoustic wave transmission through the material. For example, the number may be 2 to 10,000, or 400 to 2,500.

Regarding the periodic arrangement, the resonating structures may not necessarily be arranged at equal intervals to function as the metamaterial, but the arrangement of the resonating structures can affect the acoustic characteristics of the metamaterial.

FIG. 4 is a schematic perspective view of another example acoustic transmission enhancer according to an embodiment of the present disclosure. FIG. 4 also shows a system without a metamaterial for comparison.

As shown in FIG. 10, without a metamaterial, the acoustic waves emitted by a transducer 42 or the like to a medium 40 are reflected by a material 41 placed in the medium 40 and hardly transmit through the material 41 (low transmission). In contrast, in an acoustic transmission enhancer 43 according to the present embodiment, since a resonance-based metamaterial 44 is placed, the acoustic waves emitted by the transducer 42 or the like to the medium 40 transmit through the material 41 placed in the medium 40 (high transmission). This is because the metamaterial 44 to which the acoustic waves were emitted gives rise to resonance in a local frequency range.

FIG. 4 shows an example of the metamaterial 44 in which resonating structures 45 having the same shape and the same dimensions are arranged. Yet, the metamaterial according to the present embodiment may include multiple types of resonating structures having different shapes and/or different dimensions from each other.

The frequency applicable to the acoustic transmission enhancer according to the present embodiment, i.e., the frequency of acoustic waves targeted for transmission enhancement, is not limited. The frequency can be any frequency of interest to acoustic applications. Specifically, the acoustic transmission of the frequency may be enhanced at any frequency of 300 GHz or less. The frequency may range from 200 GHz to 300 GHz, 400 kHz to 600 kHz, or 20 kHz to 60 kHz. Each range includes boundary values. By changing the design and dimensions of the resonating structure, the frequency applicable to the acoustic transmission enhancer according to the present embodiment can be appropriately changed within the above range.

The acoustic waves to be emitted to the acoustic transmission enhancer according to the present embodiment may be ultrasound, e.g., acoustic waves higher than 20 kHz.

Table 2 below shows whether the metamaterial has the acoustic transmission enhancement effect on consecutive frequency bands.

TABLE 2

| Frequency | Transmittance with Metamaterial |
|---|---|
| Hz-KHz | Good |
| KHz-MHz | Good |
| MHz-GHz | Good |
| GHz-THz | Fair |

As shown in Table 2, the frequency can be any frequency of interest to the acoustic application, ranging from a few Hz to GHz. The acoustic transmission enhancement effect is high particularly in the frequency band lower than the GHz band.

Basically, the smaller the dimensions of the resonating structure of the metamaterial, the higher the frequency of acoustic targeted for transmission enhancement. In contrast, the larger the dimensions of the resonating structure of the metamaterial, the lower the frequency of acoustic waves targeted for transmission enhancement.

### Acoustic Transmission Enhancement System

Next, the acoustic transmission enhancement system according to an embodiment of the present disclosure is described.

The acoustic transmission enhancement system according to the present embodiment includes a material placed in a medium, a resonance-based metamaterial placed on the material, and a transducer that emits acoustic waves to the material and the metamaterial through the medium, wherein the system enhances the acoustic transmission through the material. The acoustic transmission enhancement system according to the present embodiment includes a resonance-based metamaterial and thus can enhance the acoustic transmission through the material placed in the medium.

The medium, material, and metamaterial are as described above for the acoustic transmission enhancer according to the present embodiment. Thus, the transducer is described below.

The transducer is a sound source (transmitter) that converts electrical signals to acoustic waves, preferably, ultrasound. The transducer emits acoustic waves to the material and the metamaterial through the medium.

The frequency of acoustic waves emitted by the transducer is not limited and may be any frequency of interest to the acoustic application. Specifically, the frequency may be any frequency of 300 GHz or less. The frequency range is preferably 1 kHz or more and 1,000 kHz or less, more preferably 1 MHz or more and 300 GHz or less.

The dimensions of the transducer are not limited. Smaller dimensions result in higher acoustic wave transmission through the material. For example, the diameter of an acoustic wave transmitting portion of the transducer may be 1 mm to 100 mm, or 20 mm to 50 mm.

The distance between the transducer and the material or the metamaterial (whichever closer to the transducer) is not limited and can be suitably set. For example, the distance may be 1 mm to 100 mm, or 1 cm to 10 m.

The angle of incidence of the acoustic wave transmitted by the transducer to the material is not limited. The angle range may be from −1° to 1° or from 9° to 11°. Here, the angle of incidence is 0° in the direction perpendicular to the material. Each range includes boundary values.

### EXAMPLES

Examples that more specifically disclose the acoustic transmission enhancer and the acoustic transmission enhancement system of the present disclosure are described below. The present invention is not limited to these examples.

### Example 1

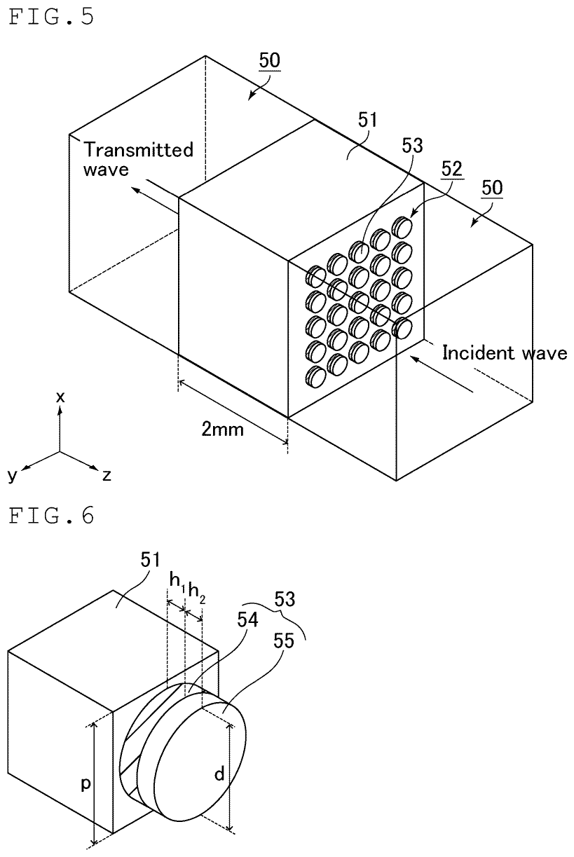

FIG. 5 is a schematic perspective view of a simulation model according to Example 1.

As shown in FIG. 5, in the present example, the acoustic transmission was simulated in a model in which a metamaterial 52 was placed in a polypropylene (PP) plate 51 placed in air 50. The 2 mm-thick polypropylene plate 51 was placed in the air 50, and multiple cylindrical resonating structures 53 were arranged regularly in a 50 by 50 matrix on one surface of the polypropylene plate 51. The diameter of a transducer (not shown) was set to 47 mm, and acoustic waves of 40 kHz were emitted by the transducer to the metamaterial 52.

FIG. 6 is a schematic perspective view of a resonating structure used in the simulation according to Example 1.

As shown in FIG. 6, each resonating structure 53 has a cylindrical shape having a constant diameter and consisting of two materials. A root portion functions as a spring 54, and an end portion consisting of a material heavier than the spring 54 functions as a mass 55.

Table 3 below shows dimensions of each resonating structure 53. p is the length of one side of a square region on which each resonating structure 53 is placed. d is the diameter of the resonating structure 53. h₁ is a height of the spring 54. h₂ is the height of the mass 55.

TABLE 3

| | |
|---|---|
| p | 10e−4[m] |
| d | 9e−4[m] |
| h₁ | 8.182e−5[m] |
| h₂ | 3.125e−4[m] |

Table 4 below shows physical property values of Tango plus FLX930 (Stratasys), which is a rubber-like flexible material for use in 3D printers, and physical property values of Durus (Stratasys), which is simulated polypropylene also for use in 3D printers. For the spring 54, physical property values of Tango plus FLX930, which is a simulated rubber, were used. For the mass 55 and the polypropylene plate 51, physical property values of Durus, which is a simulated polypropylene, were used.

TABLE 4

| | Density | Bulk modulus | Poisson's ratio |
|---|---|---|---|
| Tango plus FLX930 | 1120 | 0.3 MPa | 0.49 |
| (Rubber-like) | kg/m\hat{ }3 | (assumed) | (assumed) |
| Durus (Simulated | 1160 | 1.1 GPa | 0.33 |
| polypropylene) | kg/m\hat{ }3 | | (assumed) |

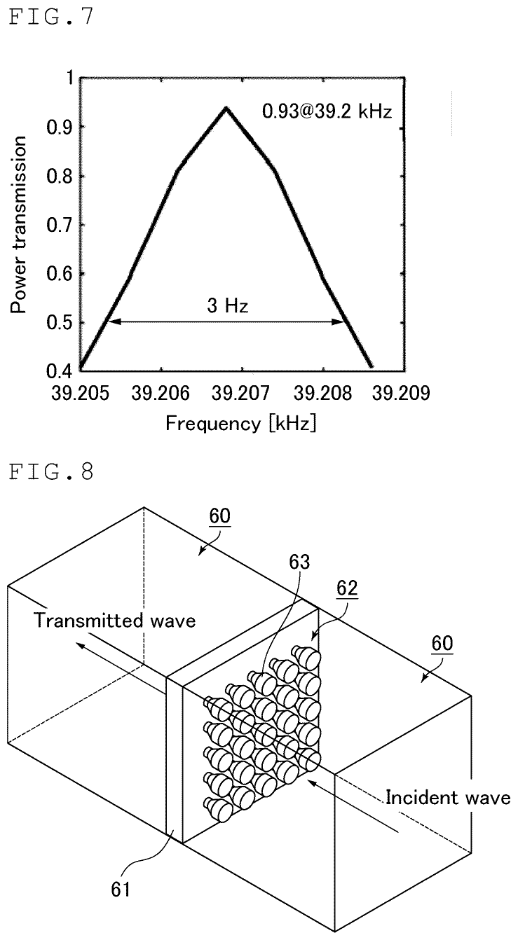

FIG. 7 is a graph showing results of simulation according to Example 1, with power transmission plotted against frequency.

As shown in FIG. 7, the metamaterial transmitted 40 kHz ultrasound beyond a 2 mm-thick polypropylene plate with above 90% acoustic power transmission. The underlying mechanism consists of two materials: a plastic cylinder works as a mass, and a rubber cylinder attached thereto works as a spring. These two materials collectively gave rise to local resonance of 40 kHz and consequently facilitated ultrasound transmission through the material.

### Example 2

FIG. 8 is a schematic perspective view of a simulation model according to Example 2.

As shown in FIG. 8, in the present example, the acoustic transmission was simulated in a model in which a metamaterial 62 was placed in a stainless steel plate 61 placed in water 60. The 1 mm-thick stainless steel plate 61 was placed in the water 60, and multiple cylindrical resonating structure 63 having a narrow side adjacent to the stainless steel plate 61 were arranged regularly in a 20 by 20 matrix on one surface of the stainless steel plate 61. The diameter of the transducer (not shown) was set to 19 mm, and 500 kHz acoustic waves were emitted by the transducer to the metamaterial 62.

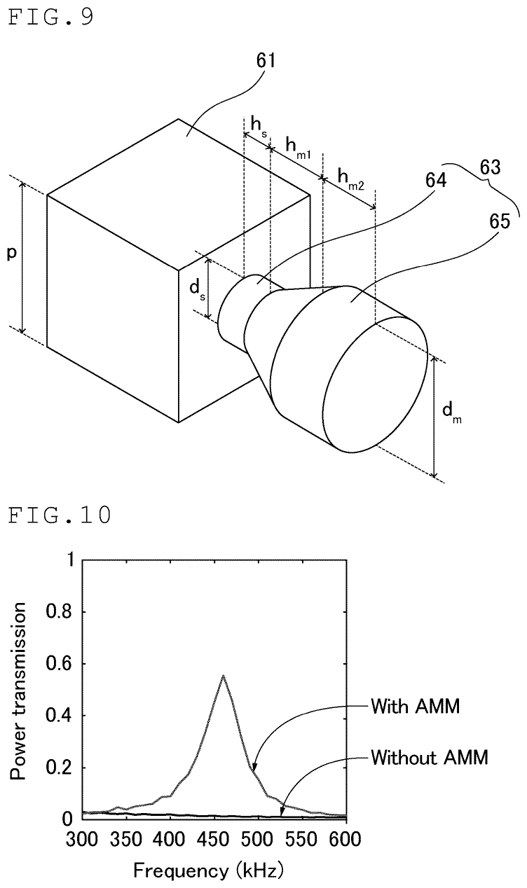

FIG. 9 is a schematic perspective view of a resonating structure used in the simulation according to Example 2.

As shown in FIG. 9, each resonating structure 63 has a cylindrical shape having a narrow side adjacent to the stainless steel plate 61 and consisting of a single material. A root portion functions as a spring 64, and an end portion functions as a mass 65.

Table 5 below shows the dimensions of each resonating structure 63. p is the length of one side of a square region on which each resonating structure 63 is placed. dₘ is the diameter of the mass 65. dₛ is the diameter of the spring 64. hₘ₁ is the height of a tapered portion of the mass 65. hₘ₂ is the height of a cylindrical portion of the mass 65. hₛ is the height of the spring 64.

TABLE 5

| | | |
|---|---|---|
| P | 1.5 | mm |
| dₘ | 1.35 | mm |
| dₛ | 0.54 | mm |
| hₘ₁ | 0.405 | mm |
| hₘ₂ | 0.615 | mm |
| hₛ | 0.3 | mm |

Table 6 below shows physical property values of SUS316L, which is a type of stainless steel. The physical property values of SUS316L were used for each resonating structure 63 and the stainless steel plate 61.

TABLE 6

| | SUS316L | |
|---|---|---|
| | (Stainless Steel | |
| Density | 7.91 | g/cm³ |
| Bulk Modulus | 153 | GPa |

| | |
|---|---|
| Poisson ratio | 0.34 |

FIG. 10 is a graph showing results of simulation according to Example 2 and Comparative Example 1, with power transmission plotted against frequency. For comparison, FIG. 10 also shows results of simulation according to Comparative Example 1 without a metamaterial. Comparative Example 1 used a model in which only the metamaterial 62 was removed from the model shown in FIG. 8.

As shown in FIG. 10, the simulation results showed at least 40% transmission through a 1 mm-thick SUS plate.

### Examples 3 and 3′

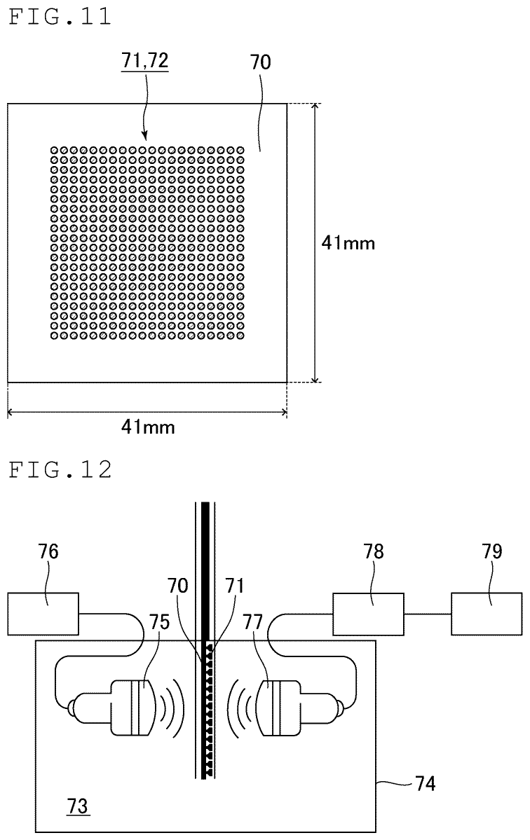

FIG. 11 is a schematic plan view of an acoustic transmission enhancer according to Example 3.

As shown in FIG. 11, a metamaterial 71 was formed on a 1 mm-thick stainless steel plate 70 having a 41 mm-side square shape using a 3D printer. Multiple resonating structures 72 were arranged regularly in a 20 by 20 matrix to provide the metamaterial 71. The stainless steel plate 70 and the metamaterial 71 were both made of SUS316L. The form and dimensions of each resonating structure 72 are as described in FIG. 9 and Table 3.

FIG. 12 is a schematic view of a setup of an experiment according to Example 3.

As shown in FIG. 12, in Example 3, the stainless steel plate 70 and the metamaterial 71 produced as shown in FIG. 11 were placed in water 73 in a tank 74. A flat transducer (transmitter) 75 having a diameter of 19 mm was placed facing the center of the metamaterial 71 at a distance of only 14 mm from the stainless steel plate 70. A pulse generator 76 was connected to the transducer 75. A receiver (transceiver) 77 was placed behind the metamaterial 71 at a distance of only 30 mm from the metamaterial 71, and the acoustic wave transmission was measured. An oscilloscope 78 was connected to the receiver 77, and a computer 79 was connected to the oscilloscope 78. The transducer 75 emitted acoustic waves of 500 kHz.

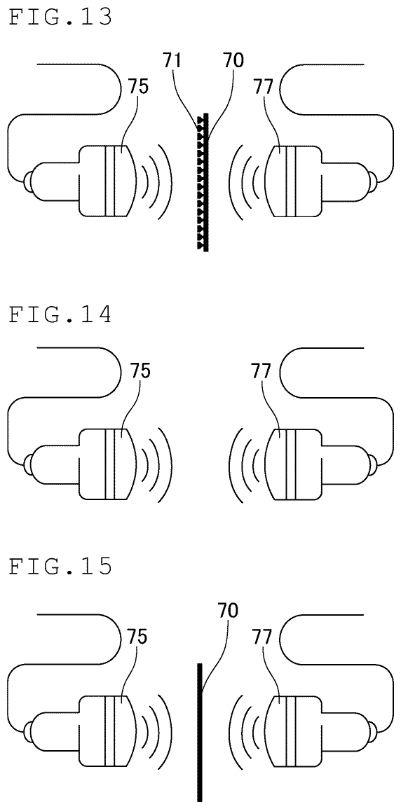

FIG. 13 is a schematic view of a setup of an experiment according to Example 3′.

As shown in FIG. 13, the setup of the experiment according to Example 3′ is the same as the setup of the experiment according to Example 3, except that the positions of the stainless steel plate 70 and the metamaterial 71 were reversed.

FIG. 14 is a schematic view of a setup of an experiment according to Comparative Example 2.

As shown in FIG. 14, in Comparative Example 2, neither a stainless steel plate nor a metamaterial was placed in the water 73 in the tank 74, and the ultrasound emitted by the transducer 75 was directly received by the receiver 77.

FIG. 15 is a schematic view of a setup of an experiment according to Comparative Example 3.

As shown in FIG. 15, the setup of the experiment according to Comparative Example 3 is the same as the setup of the experiment according to Example 3, except that the stainless steel plate 70 without a metamaterial was used.

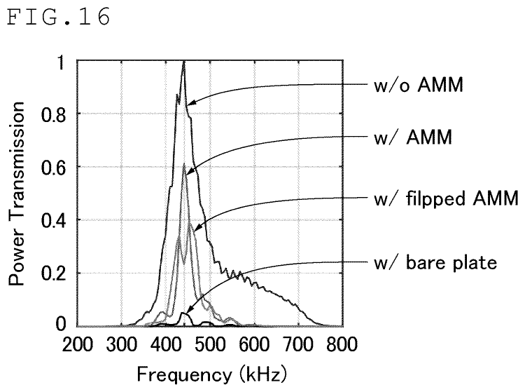

FIG. 16 is a graph showing experimental results according to Examples 3 and 3′ and Comparative Examples 2 and 3, with power transmission plotted against frequency. In FIG. 16, w/AMM shows the results of Example 3; w/flipped AMM shows the results of Example 3′; w/o AMM shows the results of Comparative Example 2; and w/bara plate shows the results of Comparative Example 3.

As shown in FIG. 16, the experimental results showed enhanced transmission through the 1 mm-thick SUS plate.

The present specification discloses the following:
(1) An acoustic transmission enhancer through a material placed in a medium, including a resonance-based metamaterial.
(2) The acoustic transmission enhancer according to (1), wherein the metamaterial includes a resonating structure to reduce acoustic energy loss due to impedance mismatch between the medium and the material, thus enhancing the acoustic transmission through the material.
(3) The acoustic transmission enhancer according to (2), wherein the ratio Z₂/Z₁ of the impedance Z₂ of the material to the impedance Z₁ of the medium is greater than 0 and 110,000 or less (except 1).
(4) The acoustic transmission enhancer according to (1) or (2), wherein the metamaterial includes an arbitrarily shaped resonating structure that gives rise to resonance in a local frequency range and consequently facilitates the acoustic transmission through the material.
(5) The acoustic transmission enhancer according to (4), wherein the resonating structure is a mass and spring-based structure that works as a resonator and gives rise to resonance in a local frequency range.
(6) The acoustic transmission enhancer according to (4) or (5), wherein the resonating structure is symmetrically shaped about an axis parallel to a traveling direction of an incident wave.
(7) The acoustic transmission enhancer according to (4) or (5), wherein the resonating structure is asymmetrically shaped about an axis parallel to a traveling direction of an incident wave.
(8) The acoustic transmission enhancer according to any one of (2) to (7), wherein the resonating structure includes multiple resonating structures periodically arranged.
(9) The acoustic transmission enhancer according any one of (1) to (8), wherein the acoustic transmission enhancer enhances the acoustic transmission through the material at any frequency of 300 GHz or less.
(10) An acoustic transmission enhancement system, including: a material placed in a medium; a resonance-based metamaterial placed on the material; and a transducer that emits acoustic waves to the material and the metamaterial through the medium, wherein the system enhances the acoustic transmission through the material.

The present specification also discloses the following:
<1> An acoustic transmission enhancer comprising a resonance-based metamaterial and a material connected to the metamaterial, wherein the metamaterial and the material are arranged such that acoustic waves pass through the metamaterial and the material in the acoustic transmission enhancer.
<2> The acoustic transmission enhancer according to <1>, wherein the metamaterial includes a resonating structure that reduces acoustic energy loss due to impedance mismatch between a medium and a material on which the metamaterial is located.
<3> The acoustic transmission enhancer according to <2>, wherein a ratio Z₂/Z₁ of an impedance Z₂ of the material to an impedance Z₁ of the medium is greater than 0 and 110,000 or less, excluding 1.
<4> The acoustic transmission enhancer according to <3>, wherein the ratio Z₂/Z₁ is 3 to 5,000.
<5> The acoustic transmission enhancer according to any one of <1> to <4>, wherein the metamaterial includes an arbitrarily shaped resonating structure that gives rise to resonance in a local frequency range.
<6> The acoustic transmission enhancer according to <5>, wherein the resonating structure is a mass and spring structure that functions as a resonator in the local frequency range.
<7> The acoustic transmission enhancer according to <6>, wherein the mass and the spring in the mass and spring structure are made of a same material or different materials.
<8> The acoustic transmission enhancer according to <6> or <7>, wherein the mass has a higher bulk modulus and higher density than the spring in the mass and spring structure.
<9> The acoustic transmission enhancer according to any one of <5> to <8>, wherein the resonating structure is symmetrically shaped about an axis parallel to a traveling direction of an incident wave.
<10> The acoustic transmission enhancer according to any one of <5> to <8>, wherein the resonating structure is asymmetrically shaped about an axis parallel to a traveling direction of an incident wave.
<11> The acoustic transmission enhancer according to any one of <2> to <10>, wherein the resonating structure includes multiple resonating structures periodically arranged.
<12> The acoustic transmission enhancer according to any one of <1> to <11>, wherein the acoustic transmission enhancer is constructed to enhance acoustic transmission through the material connected to the metamaterial at any frequency of 300 GHz or less.
<13> An acoustic transmission enhancement system, comprising: a material in a medium; a resonance-based metamaterial on the material; and a transducer that emits acoustic waves to the material and the metamaterial through the medium, wherein a straight line along a direction in which the transducer emits the acoustic waves intersects the metamaterial and the material.
<14> The acoustic transmission enhancement system according to <13>, wherein the metamaterial includes a resonating structure that reduces acoustic energy loss due to impedance mismatch between the medium and the material.
<15> The acoustic transmission enhancement system according to <14>, wherein a ratio Z₂/Z₁ of an impedance Z₂ of the material to an impedance Z₁ of the medium is greater than 0 and 110,000 or less, excluding 1.
<16> The acoustic transmission enhancement system according to any one of <13> to <15>, wherein the metamaterial includes an arbitrarily shaped resonating structure that gives rise to resonance in a local frequency range.
<17> The acoustic transmission enhancement system according to <16>, wherein the resonating structure is a mass and spring structure that functions as a resonator in the local frequency range.
<18> The acoustic transmission enhancement system according to <16> or <17>, wherein the resonating structure is symmetrically shaped about an axis parallel to a traveling direction of an incident wave.
<19> The acoustic transmission enhancement system according to claim <16> or <17>, wherein the resonating structure is asymmetrically shaped about an axis parallel to a traveling direction of an incident wave.
<20> The acoustic transmission enhancement system according to any one of <14> to <19>, wherein the resonating structure includes multiple resonating structures periodically arranged.

### REFERENCE SIGNS LIST

10, 40 medium
11, 23, 33, 41 material
12, 42, 75 transducer
13, 43 acoustic transmission enhancer
14, 44, 52, 62, 71 metamaterial
20, 30, 45, 53, 63, 72 resonating structure
21, 31, 54, 64 spring
22, 32, 55, 65 mass
50 air
51 polypropylene (PP) plate
60, 73 water
61, 70 stainless steel plate
74 tank
76 pulse generator
77 receiver
78 oscilloscope
79 computer

1. An acoustic transmission enhancer comprising a resonance-based metamaterial and a material connected to the metamaterial, wherein the metamaterial and the material are arranged such that acoustic waves pass through the metamaterial and the material in the acoustic transmission enhancer.

2. The acoustic transmission enhancer according to claim 1, wherein the metamaterial includes a resonating structure that reduces acoustic energy loss due to impedance mismatch between a medium and a material on which the metamaterial is located.

3. The acoustic transmission enhancer according to claim 2, wherein a ratio Z₂/Z₁ of an impedance Z₂ of the material to an impedance Z₁ of the medium is greater than 0 and 110,000 or less, excluding 1.

4. The acoustic transmission enhancer according to claim 3, wherein the ratio Z₂/Z₁ is 3 to 5,000.

5. The acoustic transmission enhancer according to claim 1, wherein the metamaterial includes an arbitrarily shaped resonating structure that gives rise to resonance in a local frequency range.

6. The acoustic transmission enhancer according to claim 5, wherein the resonating structure is a mass and spring structure that functions as a resonator in the local frequency range.

7. The acoustic transmission enhancer according to claim 6, wherein the mass and the spring in the mass and spring structure are made of a same material or different materials.

8. The acoustic transmission enhancer according to claim 6, wherein the mass has a higher bulk modulus and higher density than the spring in the mass and spring structure.

9. The acoustic transmission enhancer according to claim 5, wherein the resonating structure is symmetrically shaped about an axis parallel to a traveling direction of an incident wave.

10. The acoustic transmission enhancer according to claim 5, wherein the resonating structure is asymmetrically shaped about an axis parallel to a traveling direction of an incident wave.

11. The acoustic transmission enhancer according to claim 2, wherein the resonating structure includes multiple resonating structures periodically arranged.

12. The acoustic transmission enhancer according to claim 1, wherein the acoustic transmission enhancer is constructed to enhance acoustic transmission through the material connected to the metamaterial at any frequency of 300 GHz or less.

13. An acoustic transmission enhancement system, comprising:
a material in a medium;
a resonance-based metamaterial on the material; and
a transducer that emits acoustic waves to the material and the metamaterial through the medium, wherein a straight line along a direction in which the transducer emits the acoustic waves intersects the metamaterial and the material.

14. The acoustic transmission enhancement system according to claim 13, wherein the metamaterial includes a resonating structure that reduces acoustic energy loss due to impedance mismatch between the medium and the material.

15. The acoustic transmission enhancement system according to claim 14, wherein a ratio Z₂/Z₁ of an impedance Z₂ of the material to an impedance Z₁ of the medium is greater than 0 and 110,000 or less, excluding 1.

16. The acoustic transmission enhancement system according to claim 13, wherein the metamaterial includes an arbitrarily shaped resonating structure that gives rise to resonance in a local frequency range.

17. The acoustic transmission enhancement system according to claim 16, wherein the resonating structure is a mass and spring structure that functions as a resonator in the local frequency range.

18. The acoustic transmission enhancement system according to claim 16, wherein the resonating structure is symmetrically shaped about an axis parallel to a traveling direction of an incident wave.

19. The acoustic transmission enhancement system according to claim 16, wherein the resonating structure is asymmetrically shaped about an axis parallel to a traveling direction of an incident wave.

20. The acoustic transmission enhancement system according to claim 14, wherein the resonating structure includes multiple resonating structures periodically arranged.
